(19) United States
(12) Patent Application Publication
(10) Pub. No.: US 2021/0405406 A1
(43) Pub. Date: Dec. 30, 2021

(54) SEALANT AND DISPLAY PANEL

(71) Applicant: TCL CHINA STAR OPTOELECTRONICS TECHNOLOGY CO., LTD., Shenzhen, Guangdong (CN)

(72) Inventor: Yu ZHANG, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 16/754,529

(22) PCT Filed: Dec. 20, 2019
(86) PCT No.: PCT/CN2019/126844

§ 371 Date: Apr. 8, 2020

(30) Foreign Application Priority Data
Dec. 6, 2019 (CN) 201911239255.2

(51) Int. Cl. G02F 1/1339; B82Y 30/00

(52) U.S. Cl. CPC G02F 1/1339; B82Y 30/00

(57) ABSTRACT

A sealant and a display panel are provided. The sealant is doped with a solidified reinforced particle, and the solidified reinforced particle includes a metal nanoparticle and an isolation layer covering the metal nanoparticle. The sealant and the display panel can improve a pre-curing performance, thereby improving a display performance.

### FIELD OF DISCLOSURE

The present disclosure relates to the field of display technologies, and particularly to a sealant and a display panel.

### BACKGROUND

In a current liquid crystal display (LCD) technology, a sealant is required to encapsulate a liquid crystal, and then two curing processes, such as ultraviolet (UV) pre-curing and thermal curing, are performed to achieve a purpose of bonding an upper substrate and a lower substrate to encapsulate the liquid crystal.

However, with a development of panel technologies, metal lines at a position of the sealant become more and more complicated. In particular, a wide application of a gate on array (GOA) technology has made an aperture ratio at the sealant lower and lower. An aperture ratio of a special structure is even only 20%, which leads to incomplete pre-curing, that is, the pre-curing performance is poor.

If an UV pre-curing is incomplete, the upper and lower substrates are separated from each other during a process of being transported to subject a thermal curing, resulting in a liquid leakage, or a photoinitiator in the sealant is released into the liquid crystal, thereby causing mura defects, which reduces a display performance.

Therefore, it is necessary to provide a sealant and a display panel to solve the problems in the prior art.

### SUMMARY OF DISCLOSURE

An object of the present disclosure is to provide a sealant and a display panel, which can improve a pre-curing performance, thereby improving a display performance.

In order to solve the above technical problems, the present disclosure provides a sealant. The sealant is doped with a solidified reinforced particle, and the solidified reinforced particle includes a metal nanoparticle and an isolation layer covering the metal nanoparticle.

The present disclosure also provides a display panel including at least one sealant mentioned above.

In the sealant and the display panel of the present disclosure, the solidified reinforced particle is doped in the sealant. The solidified reinforced particle includes the metal nanoparticle and the isolation layer covering the metal nanoparticle. After the metal nanoparticle is irradiated with light, electrons and photons on a surface of the metal nanoparticle will resonate, which will enhance an electromagnetic field. This facilitates the curing of the sealant, thereby improving a curing performance, and further improving a display performance.

### BRIEF DESCRIPTION OF DRAWINGS

FIG. 1 is a schematic diagram of a display panel of the present disclosure.

FIG. 2 is a schematic diagram of a solidified reinforced particle of the present disclosure.

FIG. 3 is a top view of a display panel of the present disclosure.

### DETAILED DESCRIPTION

The following descriptions for the respective embodiments are specific embodiments capable of being implemented for illustrations of the present disclosure with referring to appended drawings. In the descriptions of the present disclosure, spatially relative terms, such as “upper”, “lower”, “front”, “back”, “left”, “right”, “inner”, “outer”, “side”, and the like, may be used herein for ease of description as illustrated in the drawings. Therefore, it will be understood that the spatially relative terms are intended to illustrate for understanding the present disclosure, but not to limit the present disclosure. In the appending drawings, units having similar structures are labeled by the same reference numbers.

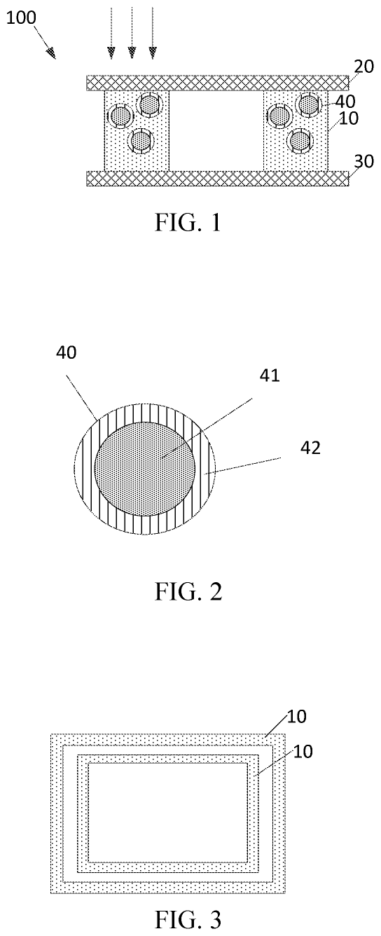

Please refer to FIG. 1 and FIG. 2, FIG. 1 is a schematic diagram of a display panel of the present disclosure.

As shown in FIG. 1, in an embodiment, a sealant 10 of the present disclosure may be disposed around a display panel 100. The sealant 10 is doped with solidified reinforced particles 40, and each of the solidified reinforced particles 40 includes a metal nanoparticle 41 and an isolation layer 42.

In one embodiment, in order to further improve a performance of UV pre-curing, the metal nanoparticle may include at least one of an Au nanoparticle, an Ag nanoparticle, a Cu nanoparticle, an Al nanoparticle. The metal nanoparticle may be other metal nanoparticle. In order to further improve the pre-curing performance, the metal nanoparticle may be a metal nanograin. In order to better improve the pre-curing performance without reducing a sealing performance of the sealant, a diameter of the metal nanoparticle ranges from 1 nm to 2000 nm. In one embodiment, a shape of the metal nanoparticle includes at least one of a sphere and a cube, but the shape of the metal nanoparticle is not limited to this.

The isolation layer 42 is coated on the metal nanoparticle 41. The isolation layer 42 is used to avoid direct contact between electrons on a surface of the metal nanoparticle and the sealant 100. In order to improve the isolation performance, material of the isolation layer 42 may include at least one of SiO2, polymethyl methacrylate (PMMA), and polyvinyl acetate (PVA). It can be understood that the material of the isolation layer is not limited to this. A thickness of the isolation layer 42 may range from 1 nm to 80 nm. Because the thickness of the isolation layer is within this range, not only the isolation performance can be improved, but also the performance of the sealant can be prevented from being reduced, thereby improving an encapsulation performance.

When light (UV) pre-curing, after the metal nanoparticle is irradiated with light, the electrons and photons on the surface of the metal nanoparticle will resonate, so that an electromagnetic field is enhanced, which is beneficial to the curing of the sealant. In particular, in a case of a low aperture ratio, it is possible to avoid incomplete UV curing of the sealant, which improves the curing performance and the display performance. In particular, when noble metal nanoparticles such as Au, Ag, Cu, and Al are used as the metal nanoparticle, a surface plasmon polariton can enhance the electromagnetic field, make the UV curing of the sealant more complete, and further improve the UV curing performance.

Referring to FIG. 1, the present disclosure also provides a display panel including the above-mentioned sealant 10. The display panel further includes an upper substrate 20 and a lower substrate 30. The sealant 10 is disposed on a periphery of the upper substrate 20 or the lower substrate 30. The upper substrate 20 may be a color filter substrate, and the lower substrate 30 may be an array substrate.

It may be understood that the display panel may further include two or more sealants. As shown in FIG. 3, when the display panel includes two sealants 10, one of the sealants surrounds the other sealant.

In a specific manufacturing process, first, the solidified reinforced particles are mixed with the sealant, and then they are applied to the periphery of the upper substrate or the lower substrate by using a conventional coating process. Then, the sealant is pre-cured with ultraviolet rays, and then it is subjected to a thermal curing process after the pre-curing is completed.

In the sealant and the display panel of the present disclosure, the solidified reinforced particle is doped in the sealant. The solidified reinforced particle includes the metal nanoparticle and the isolation layer covering the metal nanoparticle. After the metal nanoparticle is irradiated with light, electrons and photons on a surface of the metal nanoparticle will resonate, which will enhance an electromagnetic field. This facilitates the curing of the sealant, thereby improving a curing performance, and further improving a display performance.

In the descriptions of this specification, a description of a reference term such as “an embodiment”, “some embodiments”, “exemplary embodiments”, “examples”, “specific examples”, or “some examples” means that a specific feature, structure, material, or characteristic that is described with reference to the embodiment or the example is included in at least one embodiment or example of the present disclosure. In this specification, exemplary descriptions of the foregoing terms do not necessarily refer to a same embodiment or example. In addition, the described specific feature, structure, material, or characteristic may be combined in a proper manner in any one or more embodiments or examples.

Although the embodiments of the present disclosure have been shown and described, a person of ordinary skill in the art can understand that multiple changes, modifications, replacements, and variations may be made to these embodiments without departing from the principle and purpose of the present disclosure. The scope of the present disclosure is subject to the claims and equivalents thereof.

What is claimed is:

1. A sealant, comprising a solidified reinforced particle, wherein the solidified reinforced particle is doped in the sealant, and the solidified reinforced particle comprises a metal nanoparticle and an isolation layer covering the metal nanoparticle, and wherein the metal nanoparticle comprises at least one of an Au nanoparticle, an Ag nanoparticle, a Cu nanoparticle, and an Al nanoparticle, and material of the isolation layer comprises at least one of SiO2, polymethyl methacrylate (PMMA), and polyvinyl acetate (PVA).

2. A sealant, comprising a solidified reinforced particle, wherein the solidified reinforced particle is doped in the sealant, and the solidified reinforced particle comprises a metal nanoparticle and an isolation layer covering the metal nanoparticle.

3. The sealant as claimed in claim 2, wherein the metal nanoparticle comprises at least one of an Au nanoparticle, an Ag nanoparticle, a Cu nanoparticle, and an Al nanoparticle.

4. The sealant as claimed in claim 2, wherein the metal nanoparticle is a metal nanograin.

5. The sealant as claimed in claim 2, wherein a shape of the metal nanoparticle comprises at least one of a sphere and a cube.

6. The sealant as claimed in claim 2, wherein material of the isolation layer comprises at least one of SiO2, polymethyl methacrylate (PMMA), and polyvinyl acetate (PVA).

7. The sealant as claimed in claim 2, wherein a diameter of the metal nanoparticle ranges from 1 nm to 2000 nm.

8. The sealant as claimed in claim 2, wherein a thickness of the isolation layer ranges from 1 nm to 80 nm.

9. A display panel, comprising at least one sealant, wherein the sealant is doped with a solidified reinforced particle, and the solidified reinforced particle comprises a metal nanoparticle and an isolation layer covering the metal nanoparticle.

10. The display panel as claimed in claim 9, wherein the metal nanoparticle comprises at least one of an Au nanoparticle, an Ag nanoparticle, a Cu nanoparticle, and an Al nanoparticle.

11. The display panel as claimed in claim 9, wherein the metal nanoparticle is a metal nanograin.

12. The display panel as claimed in claim 9, wherein a shape of the metal nanoparticle comprises at least one of a sphere and a cube.

13. The display panel as claimed in claim 9, wherein material of the isolation layer comprises at least one of SiO2, polymethyl methacrylate (PMMA), and polyvinyl acetate (PVA).

14. The display panel as claimed in claim 9, wherein a diameter of the metal nanoparticle ranges from 1 nm to 2000 nm.

15. The display panel as claimed in claim 9, wherein a thickness of the isolation layer ranges from 1 nm to 80 nm.

16. The display panel as claimed in claim 9, further comprising an upper substrate and a lower substrate, wherein the sealant is disposed on a periphery of the upper substrate or the lower substrate.

17. The display panel as claimed in claim 9, further comprising two sealants, wherein one of the sealants surrounds the other sealant.
